(19) United States
(12) Patent Application Publication
(10) Pub. No.: US 2009/0034009 A1
(43) Pub. Date: Feb. 5, 2009

(54) Method and system for improving the quality of two-sided watermarked printed documents

(76) Inventor: Alex Lane Johnson, Washougal, WA (US)

Correspondence Address: SHARP LABORATORIES OF AMERICA, INC., 1320 PEARL ST., SUITE 228, BOULDER, CO, 80302, US

(21) Appl. No.: 11/888,058

(22) Filed: Jul. 31, 2007

(51) Int. Cl. G06K 15/00

(52) U.S. Cl. 358/3.28

(57) ABSTRACT

Methods and systems for improving the quality of two-sided watermarked printed documents through watermark alignment. An exemplary method comprises the steps of printing a watermark on the front of a sheet to create a first impression and printing the watermark on the back of the sheet to create a second impression, wherein the watermark is printed so that the first and second impressions are substantially aligned when viewed from either side of the sheet. An exemplary system may operate between a client node on which watermark selections are made by a user and a printing node on which watermark selections are applied to provide watermark alignment.

### BACKGROUND OF THE INVENTION

The present invention relates to improving the aesthetic appeal and readability of printed documents and, more particularly to reducing the impact of watermark bleed-through on the aesthetic appeal and readability of two-sided watermarked printed documents.

Many contemporary printing devices, such as multifunction printers (MFPs), support a watermark printing feature in which a user-selected text or image watermark is printed on every page of the document. The watermark is often semi-transparent so as not to render text and images printed over the watermark illegible, and often used to convey information on document status, such as “Draft”, “Original”, “Copy” or “Confidential.” The watermark is also often presented in a rotated disposition at a consistent angle throughout the document. For example, turning to FIG. 1A, a sheet 110 of a document printed in simplex mode, that is, a one-sided document, is shown having a user-selected watermark “Draft” printed diagonally thereon.

Unfortunately, when a watermark is applied to a document printed in duplex mode, that is, a two-sided document, the impression made by the watermark on the back pages (e.g. pages 2, 4, 6, 8, etc.) of the document may bleed-through to the front pages (e.g. pages 1, 3, 5, 7, etc.) of the document, and vice versa, and reduce the aesthetic appeal and readability of the document. For example, turning to FIG. 1B, a sheet 120 of a duplex-printed document is shown having a user-selected watermark “Draft” printed diagonally thereon on both sides of the sheet. The impression made by the watermark on the back page bleeds-through to the front page, rendering a visible “X” shape that reduces the aesthetic appeal and readability of the document. Naturally, a similar “X” shape is visible on the back page as well. This bleeding problem may occur in duplex printing on 20 and 24 lb. presentation weight paper, for example.

### SUMMARY OF THE INVENTION

In a basic feature, the present invention reduces the impact of watermark bleed-through on the aesthetic appeal and readability of two-sided watermarked printed documents through the expedient of watermark alignment.

In one aspect, a method for improving a two-sided watermarked printed document comprises the steps of printing a watermark on the front of a sheet to create a first impression and printing the watermark on the back of the sheet to create a second impression, wherein the watermark is printed so that the first and second impressions are at least substantially aligned when viewed from either side of the sheet. The method may further comprise the step of selecting on a user interface a watermark alignment print option or selecting on a user interface a two-sided printing print option whereby watermark alignment is automatically performed. The watermark may comprise one or more words or a wordless image. The one or more words may be printed at an angular offset from horizontal. The document may comprise a plurality of sheets and the method may comprise the steps of printing the watermark on the front of each of the plurality of sheets to create a plurality of first impressions and printing the watermark on the back of each of the plurality of sheets to create a plurality of second impressions, wherein the watermark is printed so that the first and second impressions are at least substantially aligned when viewed from either side of the sheets.

In another aspect, a printing node comprises a network interface adapted to receive from a client node a two-sided print job and a processor communicatively coupled with the network interface and adapted to generate print data for the print job wherein the print data include one or more instructions to print the watermark on a first page and a second page so that impressions made by the watermark on the front and back of a sheet will be at least substantially aligned when viewed from either side of the sheet. The printing node may further comprise a print engine and the processor may be further adapted to generate print engine-ready data for the print job wherein the print engine-ready data include a bitmap of the first and second pages having the watermark arranged so that upon printing the impressions made by the watermark on the front and back of the sheet will be at least substantially aligned when viewed from either side of the sheet. The processor may be further adapted to transmit the print-engine ready data to the print engine for application by the print engine to print a hard copy of the first and second pages wherein the hard copy includes the watermark printed so that the impressions made by the watermark on the front and back of the sheet are at least substantially aligned when viewed from either side of the sheet. The print job may include an explicit watermark alignment indication or the print job may include a two-sided print job indication from which watermark alignment may be inferred.

In another aspect, a client node comprises a user interface adapted to receive as user selections a watermark and a watermark alignment indication and a processor adapted to receive the user selections and generate and transmit to a printing node a two-sided print job wherein the print job includes the user selections for application by the printing node to print a hard copy of a first page and a second page of the print job having the watermark printed so that the impressions made by the watermark on the front and back of a sheet are at least substantially aligned when viewed from either side of the sheet.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1A shows a prior art sheet of a document printed in simplex mode having a watermark “Draft” printed diagonally on the front of the sheet.

FIG. 1B shows a prior art sheet of a document printed in duplex mode having a watermark “Draft” printed diagonally in unaligned fashion on the front and back of the sheet.

FIG. 2 shows a printing system in which the invention is operative in some embodiments of the invention.

FIG. 3 shows a client node within the printing system of FIG. 2 in more detail.

FIG. 4 shows a printing node within the printing system of FIG. 2 in more detail.

FIG. 5 shows tasks performed on a printing node in some embodiments of the invention.

FIG. 6 shows a sheet of a document printed in duplex mode having a watermark “Draft” printed diagonally in aligned fashion on the front and back of the sheet.

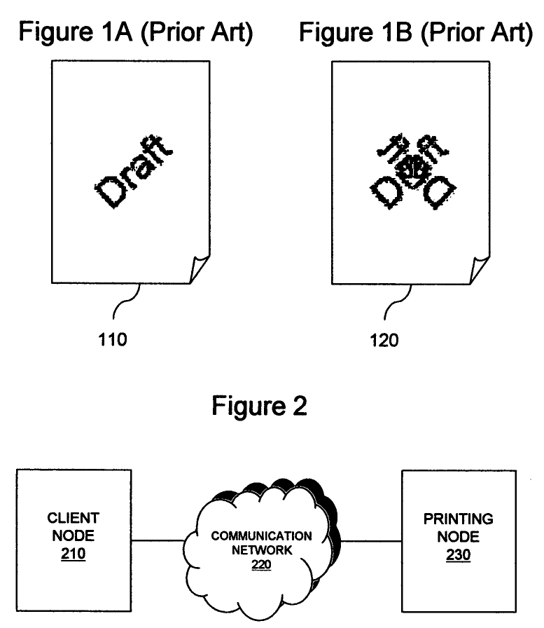

### DETAILED DESCRIPTION OF A PREFERRED EMBODIMENT

In FIG. 2, a printing system is shown in which methods and systems for improving the quality of two-sided watermarked printed documents are operative in some embodiments of the invention. The printing system includes a client node 210 communicatively coupled with a printing node 230 over a communication network 220. Client node 210 is a data communication device, such as a personal computer, workstation, cellular phone or personal data assistant (PDA), that is capable of receiving on a user interface specifications for a print job and generating and transmitting via a network interface, such as an Ethernet interface or a universal serial bus (USB) interface, a print job conformant with the specifications for printing on printing node 230. Communication network 220 may be a point-to-point connection, such as a wired or wireless Ethernet link or a USB link, or a data communication network that includes one or more LANs, WANs, WiMax networks and/or ad-hoc networks each having one or more data communication nodes, such as switches and routers, that operate to communicatively couple client node 210 and printing node 230. In some embodiments, communication network 220 traverses the Internet. In some embodiments, communication network 220 includes one or more print server nodes that act as intermediaries between client node 210 and printing node 230. Printing node 230 is a printing device having a network interface, such as an Ethernet interface or USB interface, that is capable of receiving via a network interface a print job initiated on client node 210, processing the print job and outputting a hard copy of the print job.

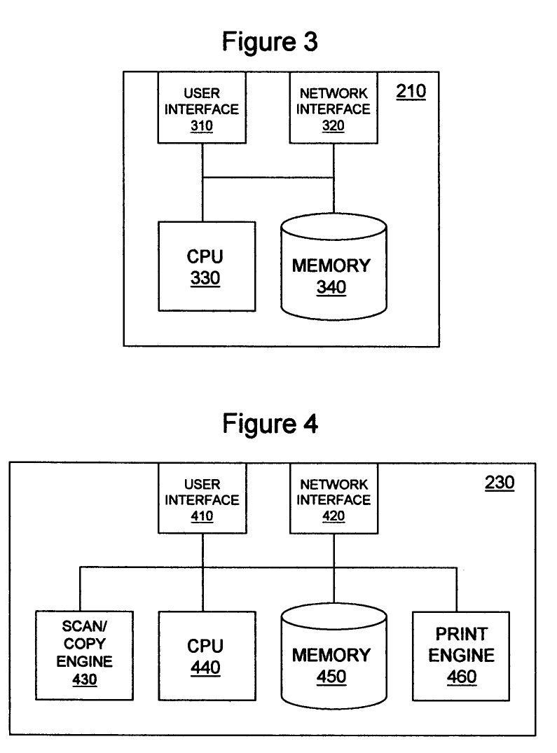

In FIG. 3, client node 210 is shown in more detail. Client node 210 has a user interface 310, a network interface 320 and a memory 340 communicatively coupled with a processor (CPU) 330. User interface 310 has an input mechanism, such as a keyboard, keypad or touch-sensitive navigation tool for accepting inputs from a user and an output mechanism, such as a liquid crystal display (LCD) or cathode ray tube (CRT) for displaying outputs to a user. Network interface 320 is a wired or wireless data communication interface, such as an Ethernet interface or a USB interface, that communicatively couples client node 210 to communication network 220. Memory 340 includes one or more random access memories (RAM) and one or more read only memories (ROM). An operating system installed in memory 340 and executed by processor 330 manages operations on client node 210 by creating, scheduling and performing various tasks, among them generating source files for print jobs conformant with print job specifications input on user interface 310 and transmitting the source files on network interface 320. The source files may have PostScript providing instruction on how text and graphics are to be printed on a page, as well as user-selected print options.

In FIG. 4, printing node 230 is shown in more detail. Printing node 230 is a multifunction printer (MFP) that supports multiple functions, such as printing, scanning and copying. Printing node 230 has a user interface 410, such as a front panel, for accepting commands from a user and displaying output to a user. Printing node 230 also has a network interface 420. Network interface 420 is a wired or wireless data communication interface, such as an Ethernet interface or a USB interface, that communicatively couples printing node 230 to communication network 220. Internal to printing node 230, interfaces 410, 420 are communicatively coupled with a processor (CPU) 440, a memory 450 a scan/copy engine 430 and a print engine 460. Scan/copy engine 430 includes scanner/copier logic, such as one or more integrated circuits (ICs), and a mechanical section for performing a scanning and copying functions. For example, scan/copy engine 430 may have a line image sensor mounted on a movable carriage for optically scanning a document under the control of a scanner IC and storing the scanned document into memory 450. Print engine 460 includes printer logic, such as one or more ICs, and a mechanical section for performing printing functions. For example, print engine 460 may have a color ink jet head mounted on a movable carriage for printing a document under the control of a printer IC. While in the illustrated embodiments a printing node 230 that supports scanning, copying and printing is shown, in other embodiments of the invention an MFP that supports additional or different functions, such as foxing, or a single-function printing device without scanning or copying capabilities may be employed.

Continuing with FIG. 4, memory 450 includes RAM and ROM. An operating system installed in memory 450 and executed by processor 440 manages operations on printing node 230 by creating, scheduling and performing various printing, scanning, copying, spooling, diagnostic and other tasks. Tasks that are performed attendant to improving the quality of two-sided watermarked printed documents include print data generation and print data rasterization. The first of these tasks, print data generation, is prompted by the receipt on network interface 420 of a source file for a print job.

In operation, a user of client node 210 initiates a two-sided print job having a watermark by selecting a document to be printed and print options on user interface 310. In some embodiments, the user selects from among numerous print options displayed on user screens. For example, the user may click a checkbox to select two-sided printing and may select a watermark from a pull-down menu that includes several watermark choices, such as “Draft”, “Original”, “Copy”, “Confidential”, “Sample”, “Urgent” and predetermined images. The user may further select an angle, color, density and size of the watermark. Additionally, in some embodiments, the user may click a checkbox to select watermark alignment. By selecting watermark alignment, the user manifests an intent that the watermark be printed such that the impressions made by the watermark on the front and back of each printed sheet of paper within the print job will be substantially aligned when viewed from either side of the sheet. It will be appreciated that such watermark alignment minimizes the impact of watermark bleed-through on the aesthetic appeal and readability of the printed document. In other embodiments of the invention, rather than requiring an explicit user selection of watermark alignment, watermark alignment is automatically performed whenever two-sided printing is selected. Once the user of client node 210 has completed user selections for the print job on user interface 310 and provided an instruction to print, processor 330 generates a source file for the print job and transmits the source file to printing node 230 via network interface 320. In some embodiments, the source file provides instruction on how text and graphics are to be printed on each page of the print job as well as user-selected print options including a two-sided printing indication, a watermark and, in some embodiments, an explicit watermark alignment indication. In other embodiments, the watermark alignment indication is inferred from the two-sided printing indication.

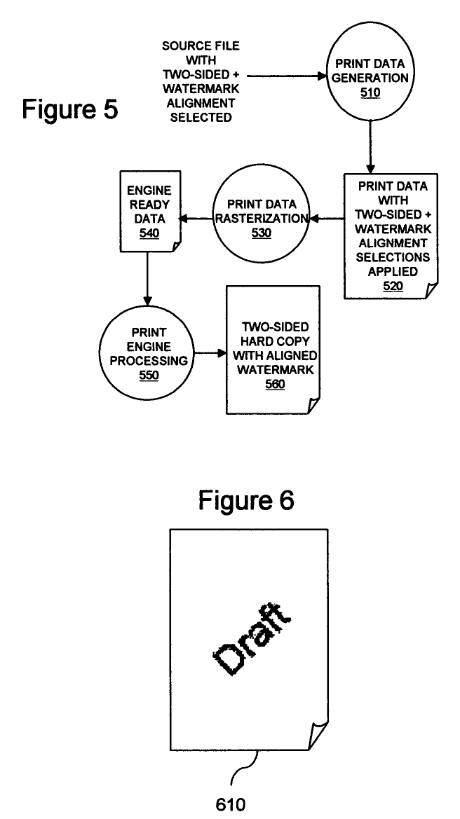

Turning now to FIG. 5, tasks performed on printing node 230 upon receiving a source file for a two-sided print job initiated on client node 210 are shown in some embodiments of the invention. Processor 440 performs a print data generation task 510 which converts the source file into print data with the two-sided, watermark and watermark alignment print options applied 520. The print data 520 is formatted in a page description language (PDL) supported by printing node 230 that determines the appearance of all pages of the print job, but at a higher level than engine-ready data that includes an actual output bitmap. Next, processor 440 performs a print data rasterization task 530, that is, raster image processing (RIP), which converts the print data 520 into print engine-ready data 540. Print engine-ready data 540 includes an actual output bitmap of all pages adapted for printing on printing node 230. Finally, print engine-ready data 540 are downloaded to print engine 460 for processing, culminating in the printing of a two-sided hard copy of the print job having a watermark on the front and back of one or more sheets whose impressions are in substantial alignment.

In some embodiments, the watermark is printed on the front and back of every sheet. In other embodiments, the watermark is suppressed on certain pages resulting in the watermark being printed on the front and back of fewer than all of the sheets. In either event, wherever the watermark is printed on the front and back of a sheet, the impressions left by the watermark are in substantial alignment when viewed from either the front or back of the sheet.

In FIG. 6, a sheet of a two-sided document having a user-selected watermark “Draft” printed diagonally in aligned fashion on the front and back is shown. Due to watermark alignment, to the extent the impression made by the watermark on the back page bleeds-through to the front page, or vice versa, the bleed area is largely within the impression made by the watermark on the other side of the sheet and therefore does not substantially impact the aesthetic appeal and readability of the document.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A method for improving a two-sided watermarked printed document, comprising the steps of:
printing a watermark on the front of a sheet to create a first impression; and
printing the watermark on the back of the sheet to create a second impression, wherein the watermark is printed so that the first and second impressions are at least substantially aligned when viewed from either side of the sheet.

2. The method of claim 1, further comprising the step of selecting on a user interface a watermark alignment print option.

3. The method of claim 1, further comprising the step of selecting on a user interface a two-sided printing print option whereby watermark alignment is automatically performed.

4. The method of claim 1, wherein the watermark comprises one or more words.

5. The method of claim 4, wherein the one or more words are printed at an angular offset from horizontal.

6. The method of claim 1, wherein the watermark comprises a wordless image.

7. The method of claim 1, wherein the document comprises a plurality of sheets and the method further comprises the steps of printing the watermark on the front of each of the plurality of sheets to create a plurality of first impressions and printing the watermark on the back of each of the plurality of sheets to create a plurality of second impressions, wherein the watermark is printed so that the first and second impressions are at least substantially aligned when viewed from either side of the sheets.

8. A printing node, comprising:
a network interface adapted to receive from a client node a two-sided print job; and
a processor communicatively coupled with the network interface and adapted to generate print data for the print job wherein the print data include one or more instructions to print a watermark on a first and a second page so that upon printing impressions made by the watermark on the front and back of a sheet will be at least substantially aligned when viewed from either side of the sheet.

9. The printing node of claim 8, further comprising a print engine, wherein the processor is further adapted to generate print engine-ready data for the print job wherein the print engine-ready data include a bitmap of the first and second pages having the watermark arranged so that upon printing impressions made by the watermark on the front and back of the sheet will be at least substantially aligned when viewed from either side of the sheet.

10. The printing node of claim 9, wherein the processor is further adapted to transmit the print-engine ready data to the print engine for application by the print engine to print a hard copy of the first and second pages wherein the hard copy includes the watermark printed so that impressions made by the watermark on the front and back of the sheet are at least substantially aligned when viewed from either side of the sheet.

11. The printing node of claim 8, wherein the print job includes an explicit watermark alignment indication.

12. The printing node of claim 8, wherein the print job includes a two-sided print job indication from which watermark alignment is inferred.

13. A client node, comprising:
a user interface adapted to receive as user selections a watermark and a watermark alignment indication; and
a processor communicatively coupled with the user interface and adapted to receive the user selections and generate and transmit to a printing node a two-sided print job including the user selections for application by the printing node to print a hard copy of each page of the print job having the watermark printed so that impressions made by the watermark on the front and back of a sheet are at least substantially aligned when viewed from either side of the sheet.

14. The client node of claim 13, wherein the watermark alignment indication is an explicit user selection.

15. The client node of claim 13, wherein the watermark alignment indication is implicit in user selection of a two-sided print job.
